(19) United States
(12) Patent Application Publication
(10) Pub. No.: US 2010/0025634 A1
(43) Pub. Date: Feb. 4, 2010

(54) METHOD OF TREATING A HYDROCARBON GAS STREAM HAVING A HIGH CARBON DIOXIDE CONCENTRATION BY USING A LEAN SOLVENT CONTAINING AQUEOUS AMMONIA

(76) Inventors: Jose Luis BRAVO, Houston, TX (US); Ashok Kumar Rupkrishen DEWAN, Sugar Lane, TX (US); Raymond Nicholas FRENCH, Sugar Land, TX (US); Amrit Lal KALRA, Sugar Land, TX (US); Pervaiz NASIR, Sugar Land, TX (US); Jiri Peter Thomas VAN STRAELEN, Amsterdam (NL)

Correspondence Address: SHELL OIL COMPANY, P O BOX 2463, HOUSTON, TX, 772522463, US

(21) Appl. No.: 12/500,235

(22) Filed: Jul. 9, 2009

Related U.S. Application Data
(60) Provisional application No. 61/079,740, filed on Jul. 10, 2008.
(60) Provisional application No. 61/180,304, filed on May 21, 2009.

(51) Int. Cl. C01B 31/20

(52) U.S. Cl. 252/372

(57) ABSTRACT

A process for the treatment of a high-pressure hydrocarbon gas stream to make a carbon dioxide-rich product stream and a treated hydrocarbon gas product stream by contacting within a contactor the high-pressure hydrocarbon gas stream with a solvent containing aqueous ammonia and, optionally, a reaction product of a liquid ammonia-carbon dioxide-water system. A fat solvent containing precipitated solids is withdrawn from the contactor and is regenerated whereby carbon dioxide is released and the fat solvent and a lean solvent is provided for reuse as the solvent.

This application claims the benefit of U.S. Provisional Application No. 61/079,740 filed Jul. 10, 2008, and U.S. Provisional Application No. 61/180,304 filed May 21, 2009, the entire disclosures of which are hereby incorporated by reference.

The invention relates to a method of treating a high-pressure hydrocarbon stream having a high concentration of carbon dioxide to remove carbon dioxide therefrom and to yield a treated gas stream and a carbon dioxide-rich stream.

There are numerous sources of hydrocarbon gas that contain such significant concentrations of carbon dioxide that the gas from these sources is unsuitable for uses such as the introduction into pipelines for sale and delivery to end-users. Among these sources is gas from natural gas reservoirs that may have such high concentrations of carbon dioxide that conventional methods of removing the carbon dioxide are not economical or even technically feasible, thus, making these reservoirs non-producible. Also, with recent concerns over the release of greenhouse gases into the atmosphere, the separation of large volumes of carbon dioxide from natural gas streams containing large concentrations of carbon dioxide can be problematic.

The prior art describes past efforts to find ways of removing small concentrations of carbon dioxide from sour natural gas. For instance, U.S. Pat. No. 3,524,722 discloses a method of removing carbon dioxide from natural gas by chemically reacting the carbon dioxide with liquid ammonia to thereby form solid ammonium carbamate. The '722 patent teaches that, in its process, natural gas is bubbled through liquid ammonia contained in a reactor vessel in which the carbon dioxide reacts with the ammonia to form solid ammonium carbamate, which settles to the bottom of the reactor vessel. A slurry is removed from the reactor vessel and is passed to a converter by which the ammonium carbamate is converted to urea in accordance with the following reaction formula: NH₂CO₂NH₄→(NH₂)₂CO+H₂O. The natural gas stream to be purified can be at a relatively high pressure, but there is no suggestion in the '722 patent that the gas streams to be treated may have excessively high concentrations of carbon dioxide. It is also noted that the process taught does not use aqueous ammonia and that the carbon dioxide is ultimately removed in the form of a urea reaction product.

U.S. Pat. No. 4,436,707 discloses a process for removing acid gases, such as carbon dioxide and hydrogen sulfide, from natural gas streams by the use of a methanol washing liquid that contains ammonia. The amount of ammonia contained in the methanol is greater than 0.5 weight percent and should be sufficient to prevent the formation of solid precipitates. The '707 patent teaches an ammonia content in its methanol solvent stream that is, in effect, a relatively low amount (37 Ncm³/ml, i.e., 3.5 weight percent), thus, the methanol essentially serves as the solvent for the ammonia. There is no teaching in the '707 patent of the processing of a high pressure natural gas stream that has a high concentration of carbon dioxide, e.g., substantially greater than 3.5 volume percent CO₂, to yield a treated gas stream suitable for introduction into pipelines for sale and delivery to end-users and to yield a carbon dioxide gas stream at such a purity and pressure condition that it is suitable for sequestration. It is noted that the '707 patent does not teach the use an aqueous-based solvent, and the process of the '707 patent avoids the formation of solids.

The process disclosed in WO 2006/022885 is directed to a system or method of cleaning, downstream of a conventional air pollution control system, a combustion gas stream of residual contaminants by the use of an ammoniated solution or slurry in a NH₃—CO₂-H₂O system and of capturing CO₂ from the combustion gas stream for sequestration in concentrated form and at high pressure. The publication does not teach a process for the treatment of a high-pressure hydrocarbon stream having a high concentration of CO₂ under high pressure absorption conditions. Rather, the publication notes that the CO₂ concentration of the combustion gas, which contains essentially no hydrocarbons or hydrogen sulfide due to the combustion, is typically 10-15% for coal combustion and 3-4% for natural gas combustion. The disclosed process further involves conducting the absorption step at low temperature and low pressure (about atmospheric pressure) with the absorbent regeneration being conducted at high-pressure conditions. This pressure difference requires the process to utilize a high-pressure pump in order to allow for the regenerator to operate at high pressure.

There remains a need in the art for a method to treat high-pressure hydrocarbon streams contaminated with large concentrations of carbon dioxide in order to produce a marketable clean treated gas and a concentrated stream of carbon dioxide that is sequestration ready, or which can be used for other purposes.

The present invention provides a highly effective and cost efficient method for treating a high-pressure hydrocarbon stream contaminated with a high concentration of carbon dioxide to produce a treated hydrocarbon gas stream and a concentrated stream of carbon dioxide at a high pressure suitable for sequestration or other uses.

The method of the invention involves contacting the high-pressure hydrocarbon stream with a lean solvent, comprising aqueous ammonia and a reaction product of a liquid NH₃—CO₂-H₂O system, in a contactor under contacting conditions suitable for reacting a portion of the carbon dioxide of the high-pressure hydrocarbon stream with the lean solvent to form a carbon dioxide containing compound. The treated hydrocarbon gas stream and a fat solvent slurry comprising precipitated solids and liquid are yielded from the contactor. At least a portion of the fat solvent slurry is introduced into a regenerator for regenerating the fat solvent slurry under regeneration conditions that are suitable for the disassociation of a portion of the precipitated solids to thereby release carbon dioxide. The concentrated stream of carbon dioxide and lean solvent are yielded from said regenerator.

The treated hydrocarbon gas stream, with optional further treatment, can be suitably introduced into pipelines for sale and delivery, while the high-pressure concentrated stream of carbon dioxide can be suitably sequestered or used for other purposes such as in enhanced oil recovery, as a super-critical solvent, etc.

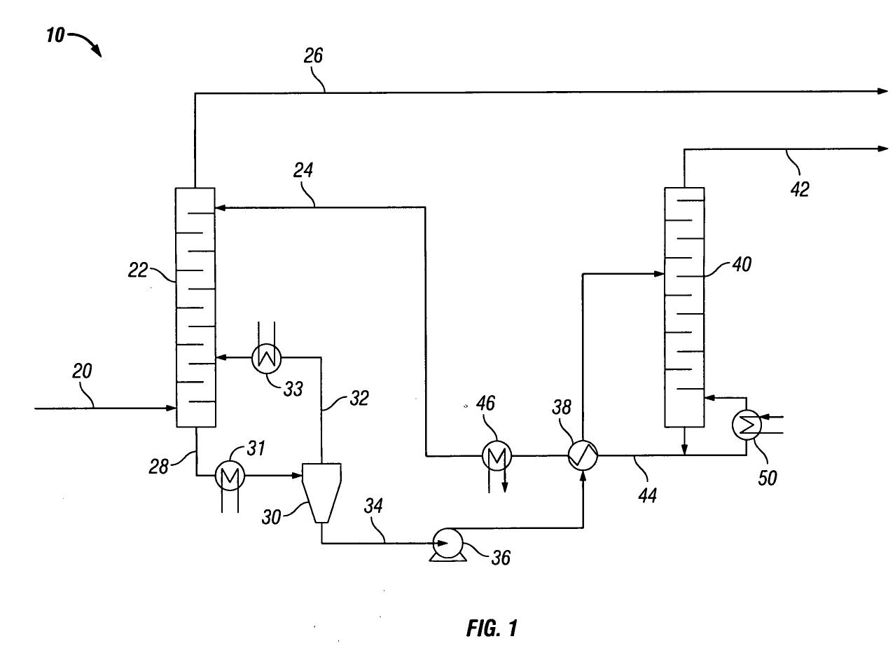

FIG. 1 is a process flow diagram showing one embodiment of the present invention.

The present method is particularly effective in removing carbon dioxide from high-pressure hydrocarbon gas streams contaminated with relatively high concentrations of carbon dioxide that can exceed 5 vol. % of such a hydrocarbon gas stream, e.g. the high concentration of carbon dioxide can be in the range of from 5 vol. % to 80 vol. % carbon dioxide, more typically, from 8 vol. % to 60 vol. %, and, most typically, from 10 vol. % to 50 vol. %.

The high-pressure hydrocarbon stream may in some cases also be contaminated with a concentration of hydrogen sulfide, e.g., in the range of from 0.5 vol. % to 20 vol. % hydrogen sulfide, or of from 1 vol. % to 15 vol. % hydrogen sulfide.

The present method is effective in removing carbon dioxide from contaminated high-pressure hydrocarbon streams.

The method also may be useful in removing hydrogen sulfide from contaminated high-pressure hydrocarbon streams.

An example of a high-pressure hydrocarbon stream which is particularly suitable for treatment in accordance with the present method is natural gas, which typically is produced at high pressures, e.g., from 10 barg to 100 barg, more typically from 50 barg to 80 barg and frequently contains varying concentrations of carbon dioxide and also hydrogen sulfide. In fact, some natural gas reservoirs contain such large concentrations of carbon dioxide that they are considered commercially uneconomical.

The present method is particularly applicable to the treatment of natural gases having large concentrations of carbon dioxide and, optionally, hydrogen sulfide, as in the aforementioned ranges, which were heretofore considered to be uneconomical and/or impractical to produce. As is typical for these natural gas sources that are highly contaminated with carbon dioxide and, optionally, hydrogen sulfide, they contain one or more gaseous hydrocarbon components. The predominant gaseous hydrocarbon component of these natural gas sources is usually methane, which is the hydrocarbon that is predominantly present among the hydrocarbon components that further include hydrocarbons such as ethane, propane, butane, pentane and, even, trace amounts of heavier hydrocarbon compounds.

Thus, in addition to having a relatively high, if not exceedingly high, concentration of carbon dioxide, and, optionally, a concentration of hydrogen sulfide, the highly contaminated high-pressure gas stream, or natural gas stream, of the inventive process can contain upwardly to or about 95 vol. % methane. Thus, methane can be present in the range of from 5 vol. % to 95 vol. % of the gas stream. But, more typically, the methane content is in the range of from 40 vol. % to 92 vol. %, and, most typically, from 60 vol. % to 90 vol. %.

In addition to the methane component, other gaseous hydrocarbons, such as, C₂H₆, C₃H₈, C₄H₁₀, and C₅H₁₂, may be present in the highly contaminated high-pressure gas stream, with each of these other gaseous hydrocarbon, or a combination of these other gaseous hydrocarbons, being present in the high-pressure hydrocarbon gas stream in the concentration range of upwardly to or about 20 vol. %, typically, from 0.1 vol. % to 15 vol. %, and, more typically, from 0.2 vol. % to 10 vol. %.

Also, small amounts of nitrogen and other inert gases, such as, Ar, He, Ne and Xe, may also be present but in relatively insignificant amounts with the nitrogen being present at a concentration of no more than 5 vol. %, and, more typically, less than 3 vol. %, but, most typically, less than 2 vol. %. The other inert gases, if present, are usually only present in small or trace amounts.

Other examples of high-pressure gas streams containing high concentrations of carbon dioxide and some hydrogen sulfide that can be treated in accordance with the present method are synthetic gases (for example from gasification or those generated during the production of unconventional oil from tar-sands or shale oils) that may contain up to 60% carbon dioxide.

In accordance with the present method, the contaminated high-pressure hydrocarbon gas stream is treated in an absorber, or contactor, that provides for contacting the contaminated high-pressure hydrocarbon gas stream with a lean solvent, which is preferably chilled and includes an aqueous ammonia (i.e., ammonia and water) solution, at a high pressure, whereby a significant portion if not most of the carbon dioxide of the high-pressure hydrocarbon gas stream, and hydrogen sulfide, if present, is removed through reaction with the lean solvent.

A treated hydrocarbon gas stream, having a substantially reduced carbon dioxide content relative to that of the contaminated high-pressure hydrocarbon gas stream, and a fat solvent slurry are yielded from the contactor. The fat solvent slurry comprises precipitated solids and a liquid, which includes ammonia and water, and may include dissolved carbon dioxide and one or more reaction products of a liquid NH₃—CO₂-H₂O system.

The precipitated solids of the fat solvent slurry may include precipitates of ammonium carbonate ((NH₄)₂CO₃), or ammonium bicarbonate ((NH₄)HCO₃), or ammonium carbamate ((NH₄)CO₃NH₂), or ammonium polycarbonate (i.e., a mixture of ammonium bicarbonate and ammonium carbonate), or ammonium sesquicarbonate (i.e., a solid mixture of ammonium carbonate, ammonium bicarbonate, ammonium carbamate), or any combination of two or more thereof.

The treated hydrocarbon gas stream may have a concentration of carbon dioxide of less than 3 vol. %, preferably, less than 2 vol. %, and, most preferably, less than 1.5 vol. %. The concentration of hydrogen sulfide, if present, of the treated hydrocarbon gas stream is less than 200 ppmv, and, preferably, less than 100 ppmv.

The hydrocarbon content of the treated hydrocarbon gas stream can be greater than 90 vol. %. Typically, in the treatment of most high-pressure hydrocarbon gas steams, the hydrocarbon content of the treated hydrocarbon gas stream can be in the range of from 90 vol. % to 99.99 vol. % of which the predominant hydrocarbon is methane. The treated hydrocarbon gas stream can, for example, comprise from 90 vol. % to 99.99 vol. % methane, less than 10 vol. % light hydrocarbons, such as ethane, propane, and butane, and less than 3 vol. % carbon dioxide.

An important feature of the present invention is that the absorber is operated at high pressure, e.g., at a pressure of from 3 barg to 40 barg, preferably, from 5 barg to 30 barg, and, most preferably, from 10 barg to 20 barg. Operation of the absorber at these high pressures has been found to reduce the amount of chilling required for the lean solvent, and it also reduces ammonia losses that can be a problem associated with low-pressure absorber operation. In addition, the reaction kinetics of the carbon dioxide with the ammonia and ammonium carbonate of the lean solvent are significantly improved at the higher pressures. The improved reaction kinetics can also provide for capital savings by reducing equipment size requirements and other benefits.

The operating temperature in the absorber will generally range from 5° C. (degrees Celsius) to 60° C., with an operating temperature in the range from 10° C. to 40° C. being preferred.

The fat solvent slurry from the absorber, or a concentrated slurry thereof, is regenerated in a regenerator column, which is operated at an elevated temperature and pressure. This results in the release of carbon dioxide (and any hydrogen sulfide, if present) from the fat solvent slurry or the concentrated slurry by decomposition of the reaction product of a liquid NH₃—CO₂-H₂O system, such as, for example, ammonium bicarbonate, ammonium carbamate and ammonium carbonate, contained therein to liberate carbon dioxide. Yielded from the regenerator column is a concentrated carbon dioxide-rich stream at high pressure suitable for sequestration and the lean solvent that preferably, at least a portion thereof, is recycled to the absorber.

The concentrated carbon dioxide stream removed from the regenerator column will generally have a high concentration of carbon dioxide, e.g., at least 90 vol. % CO₂, preferably, at least 92 vol. % CO₂, and it will be at a high pressure, e.g., above 5 barg, preferably from 25 barg to 50 barg, or higher. The fact that the present method yields a concentrated carbon dioxide stream at high pressure is a significant benefit, since one of the problems with many processes for making sequestration-ready carbon dioxide is that a compressor is required to compress the gas to the high pressures needed for storage. The operation of compressors to provide the high-pressure gas is very expensive and makes these processes uneconomical to operate.

The regenerator column is normally operated at a higher pressure than that of the high-pressure contactor, and it also is operated at a considerably higher temperature. In general, the operating pressure in the regenerator column can be in the range of from 5 barg up to 100 barg, with a pressure in the range of from 10 to 50 barg being preferred. A particularly preferred range for the operating pressure in the regenerator is from 15 barg to 40 barg.

The operating temperature in the regenerator can be in the range of from 40° C. to 240° C., or from 50° C. to 220° C. A regeneration temperature in the range of 50° C. to 180° C. is preferred, and, most preferred, the regeneration temperature is in the range of from 80° C. to 150° C.

The lean solvent used to treat the high-pressure hydrocarbon stream, having a high concentration of carbon dioxide, in accordance with the inventive method, includes an aqueous ammonia solution that comprises ammonia and water. The lean solvent may further include any one or more of the earlier described carbon dioxide containing compounds of ammonium carbonate ((NH₄)₂CO₃), ammonium bicarbonate ((NH₄)HCO₃), ammonium carbamate ((NH₄) CO₂NH₂), ammonium polycarbonate (i.e., a mixture of ammonium bicarbonate and ammonium carbonate), and ammonium sesquicarbonate (i.e., a solid mixture of ammonium carbonate, ammonium bicarbonate, ammonium carbamate), which can be reaction products of a liquid NH₃—CO₂-H₂O system.

The carbon dioxide containing compounds of the lean solvent may be present therein in the dissolved form or in the solid form, or in both forms. The lean solvent should have an ammonia (NH₃) concentration in the range of from 1 to 50 wt % of the lean solvent with the balance including water and, optionally, any one or more of the aforementioned carbon dioxide containing compounds. It is understood that the carbon dioxide containing compounds can be those formed as a result of the reactions that may occur within the liquid NH₃—CO₂-H₂O system that is formed from carbon dioxide being contacted or mixed with or dissolved within the aqueous ammonia of the lean solvent.

While not wanting to be limited to any particular theory, it is believed that the following reversible reactions occur within the liquid NH₃—CO₂-H₂O system:

2NH₃+CO₂═(NH₄)CO₂NH₂(aq/s)

2NH₃+CO₂+H₂O═2(NH₄)₂CO₃(aq/s)

(NH₄)₂CO₃(aq)+CO₂+H₂O═2(NH₄)HCO₃(aq/s)

These reactions indicate how the carbon dioxide contained in the high-pressure hydrocarbon gas stream may be absorbed into the lean solvent and removed from the high-pressure hydrocarbon gas stream by contacting it with the lean solvent. They further show how the precipitated solids of the fat solvent slurry are formed.

The above-indicated reactions also suggest the possible components of the precipitated solids of the fat solvent slurry. It is believed that the precipitated solids comprise ammonia and ammonium bicarbonate as a major portion thereof that is formed as a result of the reaction of the carbon dioxide with ammonium carbonate dissolved within the lean solvent. Due to the reversibility of the reactions, the fat solvent slurry or a concentrated slurry thereof may undergo a regeneration step, which is operated at elevated temperature and pressure conditions, to remove the absorbed carbon dioxide from the fat solvent slurry or concentrated slurry.

A preferred concentration of ammonia in the lean solvent is from 5 wt % to 35 wt %, with a more preferred ammonia concentration being in the range of from 7 wt % to 32 wt %, and, most preferred, from 9 wt % to 20 wt %.

Also, any of the reaction products of the ammonia-carbon dioxide-water system may be present in the lean solvent, and, typically, these reaction products will be present at significant concentrations. The lean solvent may include any one or combination of ammonium carbonate, ammonium bicarbonate, and ammonium carbamate, either in the dissolved form or as a precipitate solid or present both in the dissolved form and the precipitated form. The lean solvent, thus, can contain upwardly to 70 wt % of at least one of the aforementioned carbon dioxide containing compounds, but, typically, the concentration of the carbon dioxide containing compound in the lean solvent is in the range of from 1 wt % to 60 wt %.

Another important feature of the invention is that the lean solvent, which comprises aqueous ammonia, and, may further comprise a reaction product of a liquid NH₃—CO₂-H₂O, such as ammonium carbonate, in the dissolved state or the solid state, or both, is preferably chilled to a relatively low temperature, e.g., a temperature of less than 20° C., preferably less than 15° C., most preferably less than 10° C., prior to being contacted with the high-pressure hydrocarbon gas stream that is contaminated with a high concentration of carbon dioxide. Thus, suitable temperature ranges for the chilled lean solvent are from 1° C. to 20° C., preferably from 3° C. to 15° C., and, most preferably, from 5° C. to 10° C. These are the temperatures at which the lean solvent is contacted with the high-pressure hydrocarbon gas stream fed into the absorber. It has been found that by utilizing a chilled lean solvent in the absorber and operating the absorber at a high pressure, it is possible to minimize ammonia losses while maintaining a high rate of carbon dioxide absorption in the absorber.

The high-pressure hydrocarbon gas stream is normally fed to the absorber at ambient temperature, but can be chilled to a lower temperature, if it is desired to operate the absorber at a lower temperature. However, since chilling adds to the cost of the process, it is generally preferred to chill only the lean solvent, and to introduce the high-pressure hydrocarbon stream into the absorber at whatever temperature it is available (when possible, this hydrocarbon stream can be cooled by process heat integration). As long as the lean solvent is chilled to the desired contact temperature, it is capable of absorbing the carbon dioxide (and hydrogen sulfide if present) from the high-pressure hydrocarbon gas feed stream.

It is particularly desirable and beneficial for the fat solvent slurry to contain a significant concentration of precipitated solids. This is because a high solids loading of the fat solvent slurry can provide for a significantly reduced regenerator reboiler duty due to a lower lean solvent flow rate associated with the high solids loadings. Also, as a result of the higher solids loadings, the regenerator may be operated at significantly higher operating pressures than otherwise. These higher operating pressures reduce the amount of required further compression of the carbon dioxide-rich stream yielded from the regenerator. The higher solids loadings also provide for a highly efficient removal of carbon dioxide from the high-pressure hydrocarbon gas stream.

The concentration of the precipitated solids of the fat solvent slurry, thus, should be as high as is practically feasible, and, typically, the fat solvent slurry can have a precipitated solids content that is in the range of from 1 wt % to 50 wt %. Preferably, the precipitated solids are present in the fat solvent slurry in an amount in the range of from 5 wt % to 35 wt %, and, more preferably, in the range of from 10 wt % to 32 wt %.

In one embodiment of the inventive process, the solids content of the fat solvent slurry is concentrated in a step for separating the fat solvent slurry into a concentrated slurry of the precipitated solids and a recovered liquid. The concentrated slurry has a concentration of the precipitated solids that is greater than that of the fat solvent slurry fed to the separation step, and the recovered liquid has a concentration of precipitated solids that is less than that of the fat solvent slurry fed to the separation step. Thus, the concentrated slurry can have a concentration of precipitated solids that is greater than the concentration of precipitated solids of the fat solvent slurry and upwardly to 80 wt % of the concentrated slurry stream. More typically, the concentration of precipitated solids of the concentrated slurry is in the range of from 25 wt % to 75 wt %, and, most typically, from 40 wt % to 60 wt %.

To provide for a greater concentration of precipitated solids in the fat solvent slurry, an embodiment of the inventive process may provide for the cooling of the fat solvent slurry before passing it to the solids separation step. This cooling can cause the formation of additional precipitated solids over the amounts initially found in the fat solvent slurry taken directly from the contactor bottom.

The recovered liquid of the fat solvent slurry separation step may be passed as a recycle feed to be introduced into the contactor. The use of the recovered liquid as a feed to the contactor is found to promote the precipitation of the carbon dioxide containing compounds of the precipitated solids.

The invention will now be described by way of example in more detail with reference to the accompanying FIG. 1 showing one embodiment of the method of the invention.

Presented in FIG. 1 is a process flow schematic of a process 10 for treating a high-pressure hydrocarbon feed stream to yield a treated hydrocarbon gas stream and a concentrated carbon dioxide stream.

In process 10, a high-pressure hydrocarbon feed stream comprising, methane, a high carbon dioxide content, and hydrogen sulfide (for example, from 10 to 90 vol %, such as, 78 vol % methane, from 10 to 40 vol %, such as, 20 vol % carbon dioxide, and from 0 to 5 vol %, such as, 2 vol % hydrogen sulfide), is passed through conduit 20 and introduced into absorber (contactor) 22. Absorber 22 defines an absorption (contacting) zone and provides means for contacting the high-pressure hydrocarbon feed stream with a lean solvent, comprising aqueous ammonia and, optionally, a reaction product of a liquid NH₃—CO₂-H₂O system, under high-pressure and low-temperature absorption or contacting conditions. Absorber 22 can comprise multiple absorption or contacting stages.

In absorber 22, which in this embodiment is operated in its top end at a pressure of about 6 barg or higher and a temperature of about 4° C. or lower, carbon dioxide and hydrogen sulfide are absorbed in a chilled lean solvent containing aqueous ammonia (i.e., ammonia and water) solution having from or about 10 wt % to or about 20 wt % ammonia and a reaction product of a liquid NH₃—CO₂-H₂O system, such as the carbon dioxide containing compounds of ammonium carbonate, ammonium bicarbonate, ammonium carbamate, ammonium polycarbonate, and ammonium sesquicarbonate, wherein one or more of such carbon dioxide containing compounds may be present as a solute or as a solid, or as both, is introduced into absorber 22 via conduit 24 at a temperature of about 10° C. or less.

A clean treated hydrocarbon gas stream is yielded from absorber 22 through conduit 26, and a fat solvent slurry is withdrawn from and exits absorber 22 through conduit 28. Depending on the design of absorber 22 and the number of stages, the carbon dioxide present in the treated hydrocarbon gas stream will be reduced to less than 3 vol. %, preferably less than 2%, while the hydrogen sulfide in the treated gas will be reduced to less than 200 ppmv, and, preferably, to less than 100 ppmv.

The fat solvent slurry, which comprises precipitated solids that comprise at least one carbon dioxide containing compound, exits absorber 22 through conduit 28 and passes to cyclone 30. The precipitated solids content of the fat solvent slurry can be in the range of from 1 to 50 wt. % of the fat solvent slurry stream.

In one possible feature of process 10, cooler 31 is interposed in conduit 28. Cooler 31 defines a heat transfer zone for the indirect heat exchange between the fat solvent slurry and another fluid, and it provides means for the removal of heat from the fat solvent slurry so as to promote the formation of precipitated solids.

Cyclone 30 defines a separation zone and provides means for concentrating the solids content of the fat solvent slurry by separating the fat solvent slurry into a concentrated slurry of the precipitated solids and a recovered liquid. The concentrated slurry can have a concentration of precipitated solids that is greater than the concentration of precipitated solids of the fat solvent slurry and upwardly to 80 wt %.

The recovered liquid passes from cyclone 30 through conduit 32 and is introduced as a recycle feed into absorber 22 wherein it is contacted with the high-pressure hydrocarbon gas stream being fed to absorber 22. Interposed in conduit 32 is heat exchanger 33, which defines a heat exchange zone and provides means for cooling the recovered liquid passing by way of conduit 32 to absorber 22.

The concentrated slurry passes from cyclone 30 through conduit 34 to pump 36, which provides means for imparting pressure head to increase the pressure of the concentrated slurry stream to at least about 42 barg. The concentrated slurry then passes through heat exchanger 38 whereby it picks up heat from the lean solvent by means of indirect heat exchange, and, thereafter, the heated concentrated slurry is introduced into regenerator column 40.

In regenerator column 40, which in this embodiment within its top end is operated at a pressure of at least 40 barg and a temperature of at least 120° C., the carbon dioxide and hydrogen sulfide that are absorbed in the lean solvent to provide the fat solvent slurry are released from the concentrated slurry, most probably by the disassociation of the carbon dioxide containing compounds contained therein, to produce a concentrated carbon dioxide-rich gas stream containing at least 90 vol. % carbon dioxide.

The concentrated carbon dioxide-rich gas stream is removed from the upper part of regenerator column 40 through conduit 42 and is at a high pressure suitable for sequestration. It is significant that the concentrated stream of carbon dioxide that passes from regenerator column 40 by way of conduit 42 can be under such a high pressure that there is no need to employ a compressor to pressurize this stream in order to provide for its sequestration or other high pressure use.

Lean solvent is removed from the bottom of stripping column 40 though conduit 44 and passes through heat exchanger 38 by which it exchanges heat through indirect heat exchange with the concentrated slurry and, further, to chiller 46 before being returned as a recycle to absorber 22 via conduit 24. Chiller 46 provides means for removing additional heat from the lean solvent in order to cool it to the low or reduced temperature required for the operation of absorber 22. Heat is provided to stripping column 40 by means of reboiler 50.

Various changes and modifications may be made to the aforedescribed embodiments of the invention without departing from the spirit of the invention. Such obvious variations and modifications are considered to be within the proper scope of this invention.

That which is claimed is:

1. A method of treating a high-pressure hydrocarbon gas stream, comprising a high concentration of carbon dioxide, to remove therefrom carbon dioxide and to yield a treated hydrocarbon gas stream and a concentrated stream of carbon dioxide, wherein said method comprises:
contacting said high-pressure hydrocarbon stream with a lean solvent, comprising aqueous ammonia and a reaction product of a liquid NH₃—CO₂-H₂O system, in a contactor under contacting conditions suitable for reacting a portion of said carbon dioxide of said high-pressure hydrocarbon stream with said lean solvent to form a carbon dioxide containing compound;
yielding from said contactor said treated hydrocarbon gas stream and a fat solvent slurry comprising precipitated solids and liquid;
introducing at least a portion of said fat solvent slurry into a regenerator for regenerating said fat solvent slurry under regeneration conditions suitable for the disassociation of a portion of said precipitated solids to thereby release carbon dioxide; and
yielding from said regenerator said concentrated stream of carbon dioxide and said lean solvent.

2. A method as recited in claim 1, further comprising: prior to introducing said at least a portion of said fat solvent slurry into said regenerator, separating from said fat solvent slurry a portion of said liquid to thereby concentrate the solids content of said fat solvent slurry to yield a concentrated slurry of said precipitated solids and a recovered liquid; and using said concentrated slurry as said at least a portion of said fat solvent slurry that is introduced into said regenerator.

3. A method as recited in claim 2, further comprising: introducing said recovered liquid as a recycle feed into said contactor.

4. The method as recited in claim 1, wherein said high-pressure hydrocarbon gas stream comprises from 5 vol % to 80 vol % carbon dioxide and a hydrocarbon gas selected from the group consisting of methane, ethane, propane, butane, pentane and mixtures thereof.

5. The method as recited in claim 1, wherein the operating pressure of said contactor is in the range of from 5 barg to 40 barg, wherein the operating temperature in said contactor is in the range of from 5° C. and 60° C., wherein the temperature at which said lean solvent is introduced into said contactor is less than 20° C., and wherein the concentration of ammonia in said lean solvent solution is in the range of from 1 wt % to 50 wt % of said lean solvent.

6. The method as recited in claim 1, wherein the operating pressure of said regenerator is in the range of from 20 barg and 100 barg, and the operating temperature in said regenerator is in the range of from 40° C. and 180° C.

7. The method as recited in claim 1, wherein said treated hydrocarbon gas stream comprises less than 3 vol. % carbon dioxide.

8. The method as recited in claim 1, wherein said concentrated stream of carbon dioxide comprises more than 90 vol % carbon dioxide, and wherein said concentrated stream of carbon dioxide is at a pressure in the range of from 25 barg to 50 barg.

9. A method of treating a high-pressure hydrocarbon gas stream, comprising a high concentration of carbon dioxide, to remove therefrom carbon dioxide and to yield a treated hydrocarbon gas stream and a concentrated stream of carbon dioxide, wherein said method comprises:
contacting said high-pressure hydrocarbon stream with a lean solvent, comprising aqueous ammonia and at least one reaction product of a liquid NH₃—CO₂-H₂O system, in a contactor under contacting conditions suitable for reacting a portion of said carbon dioxide of said high-pressure hydrocarbon stream with said lean solvent to form a carbon dioxide containing compound;
yielding from said contactor said treated hydrocarbon gas stream and a fat solvent slurry including precipitated solids and liquid;
separating a portion of said liquid from said fat solvent slurry to thereby concentrate the solids content thereof to yield a concentrated slurry of said precipitated solids and a recovered liquid;
regenerating said concentrated slurry within a regenerator under regeneration conditions suitable for the disassociation of a portion of said precipitated solids to form carbon dioxide; and
yielding from said regenerator said concentrated stream of carbon dioxide and said lean solvent.

10. A method as recited in claim 9, further comprising: introducing said recovered liquid as a recycle feed into said contactor.

11. The method as recited in claim 9, wherein said high-pressure hydrocarbon gas stream comprises from 5 vol % to 80 vol % carbon dioxide and a hydrocarbon gas selected from the group consisting of methane, ethane, propane, butane, pentane and mixtures thereof.

12. The method as recited in claim 11, wherein the operating pressure of said contactor is in the range of from 5 barg to 40 barg, wherein the operating temperature in said contactor is in the range of from 5° C. and 60° C., wherein the temperature at which said lean solvent is introduced into said contactor is less than 20° C., and wherein the concentration of ammonia in said lean solvent solution is in the range of from 1 wt % to 50 wt % of said lean solvent.

13. The method as recited in claim 12, wherein the operating pressure of said regenerator is in the range of from 20 barg and 100 barg, and the operating temperature in said regenerator is in the range of from 40° C. and 180° C.

14. The method as recited in claim 13, wherein said treated hydrocarbon gas stream comprises less than 3 vol. % carbon dioxide.

15. The method as recited in claim 14, wherein said concentrated stream of carbon dioxide comprises more than 90 vol % carbon dioxide, and wherein said concentrated stream of carbon dioxide is at a pressure in the range of from 25 barg to 50 barg.
